(19) United States
(12) Patent Application Publication
(10) Pub. No.: US 2026/0080847 A1
(43) Pub. Date: Mar. 19, 2026

(54) Curvature Interpolation for Lookup Table

(71) Applicant: Apple Inc., Cupertino, CA (US)

(72) Inventors: Alexey Kornienko, Watford (GB); Jian Zhou, Pleasanton, CA (US); Mahesh B. Chappalli, San Jose, CA (US)

(21) Appl. No.: 18/886,538

(22) Filed: Sep. 16, 2024

(51) Int. Cl. G09G 5/06; G09G 5/02

(52) U.S. Cl. CPC G09G 5/06; G09G 5/026; G09G 2320/0673

(57) ABSTRACT

Circuitry may include a memory that stores a plurality of entries respectively mapping a defined input value to a defined output value. The circuitry may also include processing circuitry that receives an input value having a value between first and second defined input values, determines coefficients defining a curvature between first and second defined output values corresponding to the first and second defined input values, and determines an output value based on the input value and the curvature defined by the coefficients.

### BACKGROUND

The present disclosure relates generally to curvature interpolation to obtain data from a lookup table, such as using curvature interpolation during image data processing.

Electronic devices often use one or more electronic displays to present visual representations of information as text, still images, and/or video. Such electronic devices may include computers, mobile phones, portable media devices, tablets, televisions, virtual-reality headsets, and vehicle dashboards, among many others. To display an image, an electronic display may control light emission of its display pixels based at least in part on corresponding image data.

Various image processing techniques may be used to adjust the image data to be displayed by an electronic device. Such techniques may include gamma correction, distortion correction, or scaling, among other adjustments, to change the corresponding image data. Some image processing techniques may involve applying a particular function to the image data depending on some criteria, such as based on a vertical and horizontal location of the image data on an electronic display. Rather than the values of the function being calculated during runtime, the values may be precalculated and stored in a lookup table (LUT) in memory. At runtime, the appropriate values of the function may be quickly retrieved from the LUT. Although an LUT that included an entry for every possible value of the function could be very precise, it may be difficult to store an LUT that includes a large number of values (e.g., such an LUT could take up a tremendous amount of memory). Instead, an LUT instead may contain fewer entries, but intermediate values may be obtained using a form of linear interpolation. While performing linear interpolation may provide sufficient precision for an LUT representing a relatively simple function, for an LUT representing a more complex function, performing linear interpolation may not obtain sufficiently precise values and/or the LUT may take up an unacceptable amount of memory to enable linear interpolation to obtain sufficiently accurate values at a desired precision.

### SUMMARY

Since performing linear interpolation may not obtain sufficiently precise values and/or may be resource-intensive, more precise and efficient techniques to obtain a value may be desired. Embodiments disclosed herein are directed towards techniques for determining an interpolated output value that is not mapped by an entry in the LUT using curvature interpolation. Performing curvature interpolation may include using the output values of certain entries, such as entries adjacent to the virtual entry, to determine the output value associated with the input value set of the received image data. For example, the relationship (e.g., a non-linear relationship) between the respective output values of the entries and the respective input values of the entries, as well as the position of the virtual entry relative to the entries, may be used to derive the corresponding output value.

Further, curvature interpolation may include determining a curve including corresponding values corresponding to the respective output values of the entries. Coefficients of a curvature may be determined by minimizing an error between the corresponding values of the curve and the respective output values. For example, the error to be minimized may include a mean square error (MSE) between the corresponding values of the curve and the respective output values. Determining the curve as such may produce more precise output values and/or may consume less computational resources. For example, determining the curve based on a minimization of an error between corresponding values of the curve and respective output values may substantially reduce a number of calculations used to determine an output value.

### BRIEF DESCRIPTION OF THE DRAWINGS

Various aspects of this disclosure may be better understood upon reading the following detailed description and upon reference to the drawings in which:

FIG. 1 is a block diagram of an electronic device that includes an electronic display, in accordance with an embodiment;

FIG. 2 is an example of the electronic device of FIG. 1 in the form of a handheld device, in accordance with an embodiment;

FIG. 3 is another example of the electronic device of FIG. 1 in the form of a tablet device, in accordance with an embodiment;

FIG. 4 is another example of the electronic device of FIG. 1 in the form of a computer, in accordance with an embodiment;

FIG. 5 is another example of the electronic device of FIG. 1 in the form of a watch, in accordance with an embodiment;

FIG. 6 is another example of the electronic device of FIG. 1 in the form of a computer, in accordance with an embodiment;

FIG. 7 is a perspective view of a headset representing an example of the electronic device of FIG. 1, according to embodiments of the present disclosure;

FIG. 8 is a schematic diagram of a portion of the electronic device of FIG. 1 including an application processor and a display pipeline, in accordance with an embodiment;

FIG. 9 is a schematic diagram of an embodiment of a one-dimensional lookup table (LUT) having various existing entries that may be referenced by an image data processing block of the display pipeline of FIG. 8 to process image data, in accordance with an embodiment; and

FIG. 10 is a schematic diagram of curvature interpolation circuitry that determines an output value based on defined output values of a LUT and coefficients of a curvature measurement, in accordance with an embodiment.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers'specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “including” and “having” are intended to be inclusive and mean that there may be additional elements other than the listed elements. Additionally, it should be understood that references to “one embodiment,” “an embodiment,” “embodiments,” and “some embodiments” of the present disclosure are not intended to be interpreted as excluding the existence of additional embodiments that also incorporate the recited features. Furthermore, the phrase A “based on” B is intended to mean that A is at least partially based on B. Moreover, the term “or” is intended to be inclusive (e.g., logical OR) and not exclusive (e.g., logical XOR). In other words, the phrase A “or”B is intended to mean A, B, or both A and B.

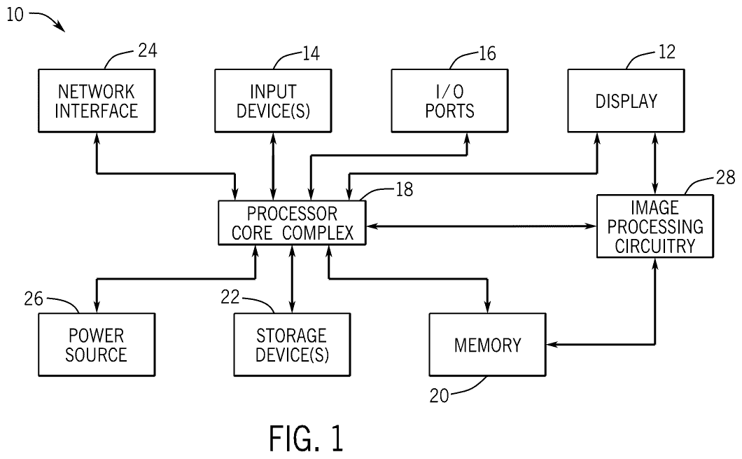

FIG. 1 is a block diagram of an electronic device 10 including an electronic display 12, according to embodiments of the present disclosure. As is described in more detail below, the electronic device 10 may be any suitable electronic device, such as a computer, a mobile phone, a portable media device, a tablet, a television, a virtual-reality headset, a wearable device such as a watch, a vehicle dashboard, earphones, a headset, or the like. Thus, it should be noted that FIG. 1 is merely one example of a particular implementation and is intended to illustrate the types of components that may be present in an electronic device 10.

The electronic device 10 includes the electronic display 12, one or more input devices 14, one or more input/output (I/O) ports 16, a processor core complex 18 having one or more processing circuitry(s) or processing circuitry cores, local memory 20, a main memory storage device 22, a network interface 24, a power source 26 (e.g., power supply), and image processing circuitry 28. The various components described in FIG. 1 may include hardware elements (e.g., circuitry), software elements (e.g., a tangible, non-transitory computer-readable medium storing executable instructions), or a combination of both hardware and software elements. It should be noted that the various depicted components may be combined into fewer components or separated into additional components. For example, the local memory 20 and the main memory storage device 22 may be included in a single component. Further, it should be noted that the electronic device 10 may include dithering circuitry to perform embodiments described herein. Additionally, the image processing circuitry 28 (e.g., a graphics processing unit) may be included in the processor core complex 18.

The processor core complex 18 is operably coupled with local memory 20 and the main memory storage device 22. Thus, the processor core complex 18 may execute instructions stored in local memory 20 and/or the main memory storage device 22 to perform operations, such as generating or transmitting image data to display on the electronic display 12. As such, the processor core complex 18 may include one or more processors, one or more general purpose microprocessors, one or more application specific integrated circuits (ASICs), one or more field programmable logic arrays (FPGAs), or any combination thereof. In some embodiments, a system on a chip (SoC) may include the processor core complex 18, among other things.

In addition to program instructions, the local memory 20 or the main memory storage device 22 may store data to be processed by the processor core complex 18. Thus, the local memory 20 and/or the main memory storage device 22 may include one or more tangible, non-transitory, computer-readable media. For example, the local memory 20 may include random access memory (RAM) and the main memory storage device 22 may include read-only memory (ROM), rewritable non-volatile memory such as flash memory, hard drives, optical discs, or the like.

The network interface 24 may communicate data with another electronic device or a network. For example, the network interface 24 (e.g., a radio frequency system) may enable the electronic device 10 to communicatively couple to a personal area network (PAN), such as a Bluetooth network, a local area network (LAN), such as an 802.11x Wi-Fi network, or a wide area network (WAN), such as a 4G, Long-Term Evolution (LTE), or 5G cellular network.

The power source 26 may provide electrical power to one or more components in the electronic device 10, such as the processor core complex 18 or the electronic display 12. For example, the power source 26 may include a power supply rail and/or a ground terminal coupled to the one or more components in the electronic device 10, such as the processor core complex 18 or the electronic display 12, to provide the electrical power. Thus, the power source 26 may include any suitable source of energy, such as a rechargeable lithium polymer (Li-poly) battery or an alternating current (AC) power converter.

The I/O ports 16 may enable the electronic device 10 to interface with other electronic devices. For example, when a portable storage device is connected, the I/O port 16 may enable the processor core complex 18 to communicate data with the portable storage device. The input devices 14 may enable user interaction with the electronic device 10, for example, by receiving user inputs via a button, a keyboard, a mouse, a trackpad, or the like. The input device 14 may include touch-sensing components in the electronic display 12. The touch sensing components may receive user inputs by detecting occurrence or position of an object touching the surface of the electronic display 12.

The electronic display 12 may control light emission from display pixels to present visual representations of information, such as a graphical user interface (GUI) of an operating system, an application interface, a still image, or video content, by displaying frames based at least in part on corresponding image data. The electronic display 12 may display frames of image data based at least in part on image data generated by the processor core complex 18 and/or by the image processing circuitry 28. Additionally or alternatively, the electronic display 12 may display frames based at least in part on image data received via the network interface 24, an input device, and/or one of the I/O ports 16.

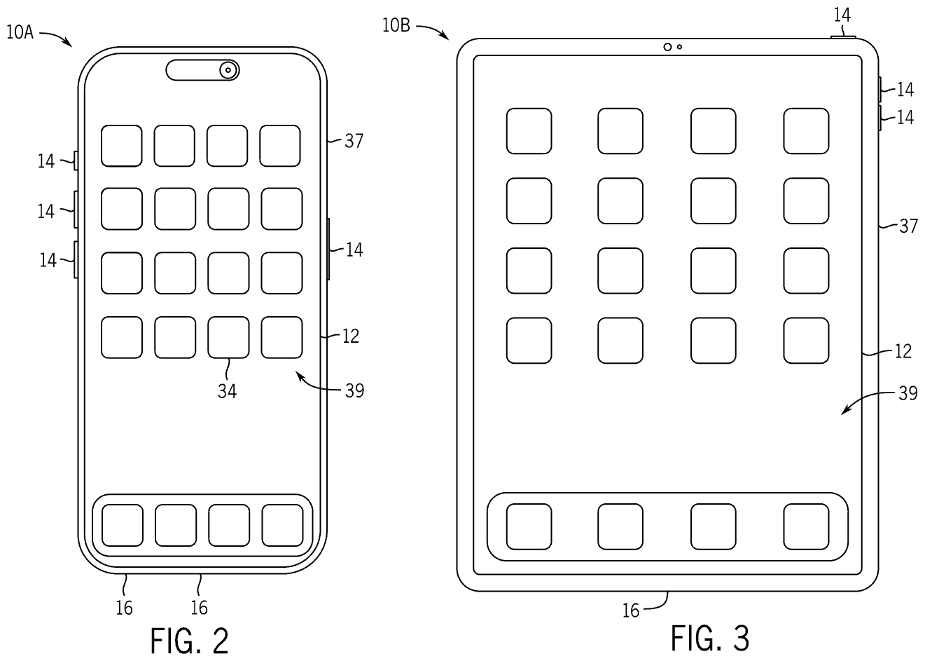

To help illustrate, an example of the electronic device 10, a handheld device 10A, is shown in FIG. 2. The handheld device 10A may be a portable phone, a media player, a personal data organizer, a handheld game platform, or the like. For illustrative purposes, the handheld device 10A may be a smart phone, such as any IPHONE® model available from Apple Inc. The handheld device 10A includes an enclosure 37 (e.g., housing). The enclosure 37 may protect interior components from physical damage or shield them from electromagnetic interference, such as by surrounding the electronic display 12. The electronic display 12 may display a graphical user interface (GUI) 39 having an array of icons. As such, when an icon 34 is selected either by an input device 14 or a touch-sensing component of the electronic display 12, an application program may launch.

The input devices 14 may be accessed through openings in the enclosure 37. The input devices 14 may enable a user to interact with the handheld device 10A. For example, the input devices 14 may enable the user to activate or deactivate the handheld device 10A, navigate a user interface to a home screen, navigate a user interface to a user-configurable application screen, activate a voice-recognition feature, provide volume control, or toggle between vibrate and ring modes.

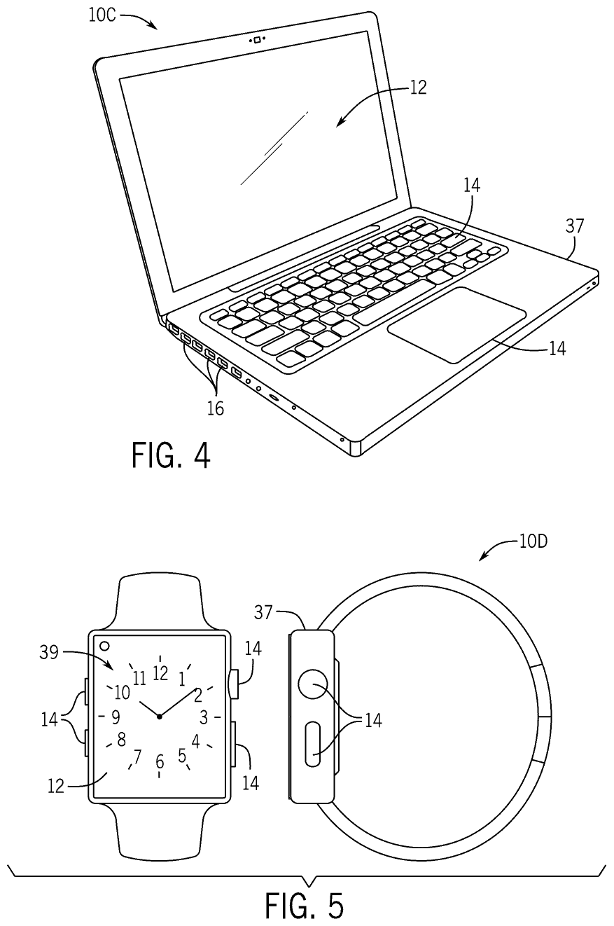

Another example of a suitable electronic device 10, specifically a tablet device 10B, is shown in FIG. 3. The tablet device 10B may be any IPAD® model available from Apple Inc. A further example of a suitable electronic device 10, specifically a computer 10C, is shown in FIG. 4. For illustrative purposes, the computer 10C may be any MACBOOK® or IMAC® model available from Apple Inc. Another example of a suitable electronic device 10, specifically a watch 10D, is shown in FIG. 5. For illustrative purposes, the watch 10D may be any APPLE WATCH® model available from Apple Inc.

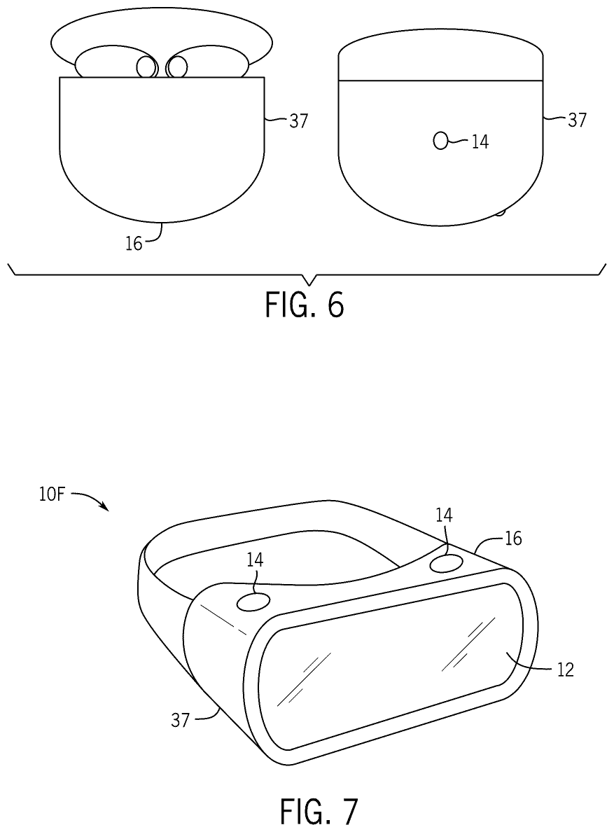

Another example of a suitable electronic device 10, specifically an audio device 10E, is shown in FIG. 6. For illustrative purposes, the audio device 10E may be any AIRPODS® model available from Apple Inc. Another example of a suitable electronic device 10, specifically a headset 10F (e.g., an extended reality (XR), mixed reality (MR), virtual reality (VR), and/or augmented reality (AR) headset), is shown in FIG. 7. For illustrative purposes, the headset 10F may be any VISION PRO® model available from Apple Inc.

As depicted, the tablet device 10B, the computer 10C, the watch 10D, and the headset 10F each also includes an electronic display 12, input devices 14, I/O ports 16, and an enclosure 37. The electronic display 12 may display a graphical user interface (GUI) 39. As shown in FIG. 5, the GUI 39 may show a visualization of a clock. When the visualization is selected either by the input device 14 or a touch-sensing component of the electronic display 12, an application program may launch, such as to transition the GUI 39 to presenting the icons 34 discussed with respect to FIGS. 2 and 3. Further as depicted, the audio device 10E may include the input devices 14, the I/O ports 16, and the enclosure 37.

In any case, as described above, processing image data may improve an image to be displayed by an electronic device. As a result, processing the image data may improve a user interaction or experience with the electronic device 10, such as by enabling the user to view an image more clearly. For example, the image processing circuitry 28 may reference an LUT and perform curvature interpolation based on entries in the LUT in order to determine an interpolation value for use in processed image data. The processed image data may then be used to display a corresponding image on the electronic display 12.

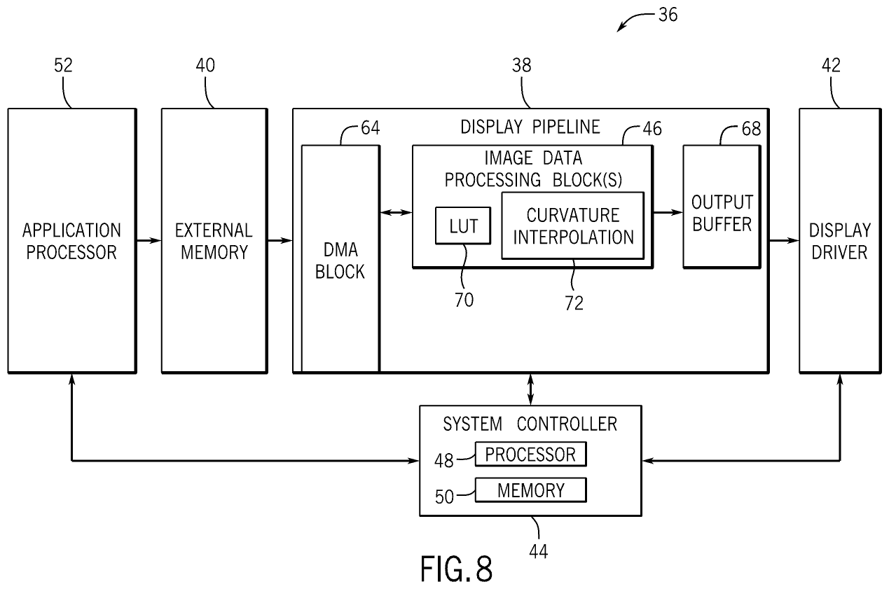

FIG. 8 is a schematic diagram of an image processing system 36 (e.g., that employs the image processing circuitry 28) that includes a display pipeline 38 and that may be implemented in an electronic device 10. The image processing system 36 also includes an external memory 40 (e.g., the local memory 20), a display driver 42, and a system controller 44, any of which may be implemented in an electronic display 12. In some embodiments, the system controller 44 may control operations of the display pipeline 38, the external memory 40, the display driver 42, and/or other portions of the electronic device 10. It is noted that the display pipeline 38 may include control circuitry, such as control circuitry similar to the system controller 44, but particular to management of communication between components of the display pipeline 38 (e.g., between image processing and/or configuration blocks).

To facilitate the controlling operation, the system controller 44 may include a controller processor 48 and controller memory 50. In some embodiments, the controller processor 48 may execute instructions stored in the controller memory 50. Thus, in some embodiments, the controller processor 48 may be included in the processor core complex 18, the image processing circuitry 28, a timing controller (TCON) in the electronic display 12, a separate processing module, or any combination thereof. Additionally, in some embodiments, the controller memory 50 may be included in the local memory 20, the main memory storage device 22, the external memory 40, an internal memory of the display pipeline 38, a separate tangible, non-transitory, computer readable medium, or any combination thereof. Although depicted as a system controller 44, in some embodiments, one or more separate system controllers 44 may be implemented to control operation of the electronic device 10.

In any case, the display pipeline 38 may operate to process image data retrieved (e.g., fetched) from the external memory 40, for example, to facilitate improving perceived image quality through the processing. An application processor 52 generates the image data and may store the image data in the external memory 40 for access by the display pipeline 38. In some embodiments, the display pipeline 38 may be implemented via circuitry, for example, packaged as a system-on-chip (SoC). Additionally or alternatively, the display pipeline 38 may be included in the processor core complex 18, the image processing circuitry 28, the TCON in the electronic display 12, another processing unit, other processing circuitry, or any combination thereof.

The display pipeline 38 may include a direct memory access (DMA) block 64, an output buffer 68, and one or more image data processing blocks 46 (e.g., an LUT 70, curvature interpolation circuitry 72). In some cases, the display pipeline 38 may include a respective LUT 70 and/or curvature interpolation circuitry 72 to perform each of numerous processing operations. For example, the LUT 70 and the curvature interpolation circuitry 72 may be used by the display pipeline 38 to perform degamma operations, and an additional LUT and/or an additional curvature interpolation block may be used by the display pipeline 38 to perform a regamma operation or other processing operation. The various blocks of the display pipeline 38 may be implemented using circuitry and/or programmable instructions executed by a processor. The display pipeline 38 may operate to retrieve image data from the external memory 40 and, upon retrieving the image data, the display pipeline 38 may process the image data before transmission to the display driver 42. The curvature interpolation circuitry 72 may refer to the LUT 70 in processing the image data, such as to perform various transformations and/or adjustments, to enhance or improve the retrieved image data to be more suitable for presentation according to current operating and/or environmental conditions. For instance, such processing may improve a brightness level, an image geometry (e.g., a symmetry), an image scaling, and/or another appearance of the image. Indeed, the image data processing block(s) 46 may perform any suitable operation to adjust the image data received by the display pipeline 38 to be suitable for presenting an image.

By way of example, color values of images to be represented by the image data may be mapped to image reproduction configurations of an output device (e.g., the electronic display 12). That is, the image data processing block(s) 46 may transform original color values received from an image capturing device (or image source) into color values to be output (e.g., by the electronic display 12). For instance, based on input values of the retrieved image data, the image data processing block(s) 46 may refer to the entries in the LUT 70 to determine corresponding output values to be applied to the image data. Indeed, for input values explicitly defined by an entry in the LUT 70, the image processing block(s) 46 may use the output value associated with the entry. Further, for input values that are not explicitly defined by an entry in the LUT 70, the curvature interpolation circuitry 72 may refer to certain entries (e.g., entries that are adjacent to a virtual entry representing the input values) to derive or interpolate an output value. Thus, the curvature interpolation circuitry 72 may facilitate adjusting the image data more accurately or desirably.

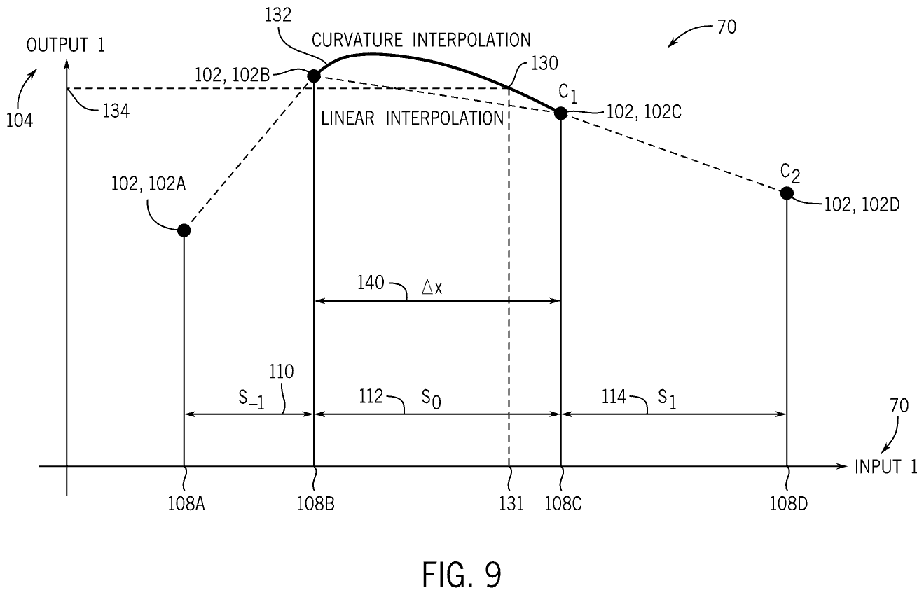

FIG. 9 illustrates an embodiment of the LUT 70 having various entries 102. Each entry 102 of the LUT 70 is illustrated as a coordinate point that is explicitly defined in the LUT 70 to map or associate an output variable 104 with an input variable 106 (e.g., a defined input value). In other words, the LUT 70 explicitly assigns values of the output variable 104 with a respective value of the input variable 106. In some embodiments, the LUT 70 may be a part of the image data processing block(s) 46 of the display pipeline 38, and the LUT 70 may be used to facilitate determining a corresponding output variable 104 to be applied to a received image data. As an example, the image data processing block(s) 46 may determine that the image data includes a value of the input variable 106 that matches that of one of the entries 102, and the image data processing block(s) 46 may refer to the LUT 70 to determine the corresponding value of the output variable 104 of the entry 102 to apply to the image data. In certain embodiments, as described above the output variable 104 may include any suitable value (e.g., a correction value, a transformation value) to be applied to the image data based on the input variable 106, such as a color adjustment value, a geometry adjustment value, a scaling value, another suitable type of value, or any combination thereof. In any case, the image data processing block(s) 46 may determine and apply values of the output variable 104 in order to transform (e.g., enhance the quality of) the image data.

In the illustrated example, a first entry 102A may include a first defined output value of the output variable 104 and a first defined input value 108A of the input variable 106. A second entry 102B may include a second defined output value of the output variable 104 and a second defined input value 108B of the input variable 106. Additionally, a third entry 102C may include a third defined output value of the output variable 104 and a third defined input value 108C. Further, a fourth entry 102D may include a fourth defined output value of the output variable 104 and a fourth defined input value 108D.

The defined input values of the entries 102 may be separated such that the fourth defined input value 108D is greater than the third defined input value 108C, the third defined input value 108C is greater than the second defined input value 108B, and the second defined input value 108B is greater than the first defined input value 108A. In the illustrated example, the second defined input value 108B is greater than the first defined input value 108A by a first interval 110, the third defined input value 108C is greater than the second defined input value 108B by a second interval 112, and the fourth defined input value 108D is greater than the third defined input value 108C by a third interval 114. Further, as described below, the illustrated relationship between the entries 102 is not linear. In other words, the values of the input variables 106 of the entries 102 are not proportionally related to the values of the corresponding output variables 104 of the entries 102.

Since the output variable 104 of each entry 102 depends on a single input variable 106, the illustrated LUT 70 is a one-dimensional LUT. In other embodiments, however, the LUT 70 may have more dimensions (e.g., two dimensions, three dimensions, four dimensions, or any suitable number n dimensions) and curvature interpolation may be used along all or only some of the dimensions. For example, a first value along a first of the dimensions may be determined using curvature interpolation and a second value along a second of the dimensions may be determined using linear interpolation. Further, although the illustrated LUT 70 includes four entries 102, the LUT 70 may include any suitable number of entries 102 that each map an input variable 106 with a corresponding output variable 104. For instance, the LUT 70 may include more than four entries 102 or fewer than four entries 102. In such examples, the four entries 102 may collectively form a segment of the LUT 70 that may include additional entries. As used here, a segment of a LUT may be understood to mean a portion of a LUT that maps a particular range of defined input values to corresponding output values. Moreover, it should be noted that the respective input variable 106 of each entry 102 may be evenly spaced from one another. That is, the step sizes between immediately adjacent entries 102 (e.g., entries 102 having respective values of the input variables 106 that are incrementally different from one another) may be the same. As used herein, a step size refers to a difference between the values of the input variables 106 of entries 102. Additionally or alternatively, the input variable 106 of each entry 102 may be unevenly spaced from one another. In other words, the step sizes between immediately adjacent entries 102 may be different from one another.

FIG. 9 also includes an interpolated entry 130 that is not explicitly defined in the LUT 70. For example, an image data may include an input value 131 of the input variable 106 that is not explicitly defined by any of the entries 102 of the LUT 70. Therefore, the LUT 70 does not explicitly define a corresponding output value 134 of the output variable 104 for the value of the input variable 106 of the image data. The input value 131, as illustrated, may be greater than the first defined input value 108A and the second defined input value 108B and may be less than the third defined input value 108C and the fourth defined input value 108D, such that the input value 131 is between the second defined input value 108B and the third defined input value 108C. The input value 131 may be greater than the second defined input value 108B by a phase 140, for instance. The corresponding output value 134 of the output variable 104 may be determined using curvature interpolation, which uses a mathematical relationship between the interpolated entry 130 and the entries 102 of the LUT 70.

By way of example, performing curvature interpolation may include using a relationship between the entries 102 (e.g., between the respective values of the output variables 104 and respective values of the input variables 106 of the entries 102) as well as using a relationship between the value of the input variable 106 of the interpolated entry 130 relative to the respective values of the input variable 106 of an immediately adjacent entry 102 to determine the corresponding value of the output variable 104 of the interpolated entry 130. In some embodiments, the entries 102 may be defined in the LUT 70 such that a curve 132 (e.g., a regression curve, a fit curve) may represent a mathematical relationship between the entries 102 (e.g., by passing through a subset of the entries 102, by substantially passing through a subset of the entries 102 within a threshold value). In the illustrated example, the curve 132 passes through the entries 102B and 102C (e.g., the entries adjacent to the interpolated entry 130). The interpolated entry 130 may be located on the curve 132 (e.g., substantially located on the curve 132 within a threshold value).

In some embodiments of curvature interpolation, the output value 134 may be determined based on an equation that directly associates or equates the value of the output variable 104 with the respective values of the output variable 104 of the entries 102 (e.g., certain entries 102 adjacent to the interpolated entry 130), the intervals between immediately adjacent entries 102, and/or a phase (e.g., the phase 140) between the interpolated entry 130 and an entry 102 that is immediately adjacent to the interpolated entry 130. As used herein, the phase refers to the difference between the value of the input variable 106 of the interpolated entry 130 and the value of the input variable 106 of one of the entries 102 immediately adjacent to the interpolated entry 130. The illustrated example uses four entries 102 to determine the output variable 104 of the interpolated entry 130. In particular, the interpolated entry 130 is positioned between the second entry 102B and the third entry 102C (e.g., the value of the input variable 106 of the interpolated entry 130 is between the respective values of the input variable 106 of the second entry 102B and of the third entry 102C). That is, the second entry 102B and the third entry 102C, which are each immediately adjacent to the interpolated entry 130, are used to determine the value of the output variable 104 of the interpolated entry 130. Furthermore, the first entry 102A, which is immediately adjacent to the second entry 102B, and the fourth entry 102D, which is immediately adjacent to the third entry 102C, are also used to determine the value of the output variable 104 of the interpolated entry 130.

Additionally or alternatively, a different set of entries 102 and/or a different number of entries 102 may be used to determine the value of the output variable 104 of the interpolated entry 130. As an example, entries 102 that are not immediately adjacent to one another or immediately adjacent to the interpolated entry 130 may be used to determine the value of the output variable 104 of the interpolated entry 130. As another example, three entries 102 may be used to determine the value of the output variable 104 of the interpolated entry 130, such as for an interpolated entry in which there are only three entries 102 that are adjacent to the interpolated entry. Further still, two entries 102 or more than four entries 102 may be used in additional or alternative embodiments, such as based on a desirable accuracy of the output variable 104 of the interpolated entry 130. Performing curvature interpolation to determine the output variable 104 of the interpolated entry 130 as described herein may preserve the resolution of the relationships represented by the LUT 70 while reducing the number of entries (e.g., to the four entries 102 of the segment 100) used to find the output variable 104. That is, while the LUT 70 may have numerous (e.g., thousands of) entries, the described curvature interpolation may characterize a curvature of the LUT using a subset of the numerous entries.

The equation may be used to calculate the value of the output variable 104 of the interpolated entry 130 by multiplying the above-referenced phase between two entries 102 (e.g., the entries immediately adjacent to the interpolated entry 130) with the quantity of a slope between the two entries 102 minus a curvature measurement of a set of entries 102 (i.e., a set of entries 102 that contains the two entries 102) as multiplied by the quantity of the step size between the two entries 102 minus the phase, then adding this calculation to the entry 102 having the lesser value of the output variable 104. The curvature measurement may generally relate the values of the respective output variables 104 of the entries 102 with one another, such as by using a discretization technique (e.g., finite difference method) and factoring in a correction value.

By way of example, with reference to the use of the four entries 102 shown in FIG. 9, the curvature measurement may include the total of a first coefficient and a second coefficient. The curvature measurement may be calculated as half of a sum of the first coefficient and second coefficient, the sum multiplied by the second interval 112. The first coefficient includes the quantity of a first difference between the defined output value of the output variable 104 of the third entry 102C and the defined output value of the output variable 104 of the second entry 102B, the first difference being divided by the second interval 112 between the second entry 102B and the third entry 102C, minus a second difference between the defined output value of the output variable 104 of the second entry 102B and the defined output value of the output variable 104 of the first entry 102A, the second difference being divided by the first interval 110 between the first entry 102A and the second entry 102B. This quantity is then multiplied by half of the inverse of a total of the third interval 114 between the second entry 102B and the third entry 102C plus the first interval 110 between the first entry 102A and the second entry 102B. Further, the second coefficient includes the quantity of a third difference between the defined output value of the output variable 104 of the fourth entry 102D and the defined output value of the output variable 104 of the third entry 102C, the third difference being divided by the third interval 114 between the third entry 102C and the fourth entry 102D, minus the first difference between the defined output value of the output variable 104 of the third entry 102C and the defined output value of the output variable 104 of the second entry 102B, the first difference being divided by the second interval 112 between the second entry 102B and the third entry 102C. This quantity is multiplied by half of the inverse of the total of the third interval 114 between the third entry 102C and the fourth entry 102D plus the second interval 112 between the second entry 102B and the third entry 102C.

In embodiments in which each of the first interval 110, the second interval 112, and the third interval 114 have the same step size, the curvature measurement may be significantly simplified. For example, the curvature measurement may be calculated as one fourth of the difference between a first difference between the defined output value of the second entry 102B and the defined output value of the first entry 102A and a second difference between the defined output value of the third entry 102C and the defined output value of the second entry 102B.

In further embodiments of curvature interpolation, an equation of the curve 132 may be determined based on statistical regression analysis (e.g., of the respective values of the input variable 106 and the respective values of the output variable 104 associated with entries 102). The equation of the curve 132 may generally associate or equate a corresponding value of the output variable 104 to any value of the input variable 106. As such, the equation of the curve 132 may be applied to the value of the input variable 106 of the interpolated entry 130 in order to determine an output value 134 of the interpolated entry 130. For example, the output value 134 of the interpolated entry may be calculated as a sum of the defined output value of the second entry 102B and the phase 140 multiplied by a difference term. The difference term may be calculated as a difference between a first difference between the defined output value of the second entry 102B and the defined output value of the first entry 102A and the curvature measurement multiplied by the difference between one and the phase 140. In any case, the output value of the interpolated entry 130 determined via curvature interpolation may be applied to the image data (e.g., to a pixel of the image data represented by the interpolated entry 130) to transform the image data.

Further, the curve 132 may have corresponding values at each of the defined input values of the entries 102. For example, the curve 132 may have a first corresponding value corresponding to the first defined output value of the first entry 102A, a second corresponding value corresponding to the second defined output value of the second entry 102B, a third corresponding value corresponding to the third defined output value of the third entry 102C, and a fourth corresponding value corresponding to the defined output value of the fourth entry 102D.

Minimizing a difference (e.g., error) between the corresponding values of the curve 132 and the defined output values of the entries 102 may be used to determine the output value 134 of the interpolated entry 130. As such, coefficients of the curvature measurement, such as the first coefficient and the second coefficient, may be determined and/or adjusted based on a minimization of an error value between the defined output values of the entries 102 and the curve 132. For example, the coefficients may be determined based on a minimization of a mean square error (MSE) between the defined output values of the entries 102 and the corresponding values of the curve 132.

To minimize the error between the corresponding values of the curve 132 and the defined output values of the entries 102, the curvature measurement may be calculated as the left matrix division of a first convolution and a second convolution. The first convolution may include a Cholesky decomposition of a triangular matrix with four non-zero diagonals. The triangular matrix may have two equal dimensions, each of the two equal dimensions based on the number of segments in a LUT and a number of intervals within each segment. For example, the LUT 70 of FIG. 9 may be considered a segment with three intervals. Each of the equal dimensions of the triangular matrix may be calculated as one more than the number of segments in the LUT and the number of intervals in each segment of the LUT.

The second convolution may include a convolution between a first matrix and a curvature calculation vector. The first matrix may have a first dimension and a second dimension, the first dimension equal to one more than the number of segments in the LUT and the number of intervals in each segment of the LUT, and the second dimension determined based on the first dimension multiplied by a number of curve calculation values per interval. In some embodiments, the first matrix is pre-calculated and has a number of non-zero elements in a column equal to one less than the number of curve calculation values per interval multiplied by four. The curvature calculation vector may include a number of corresponding points (e.g., of the curve 132) equal to one less than the number of curve calculation values per interval multiplied by the first dimension of the first matrix.

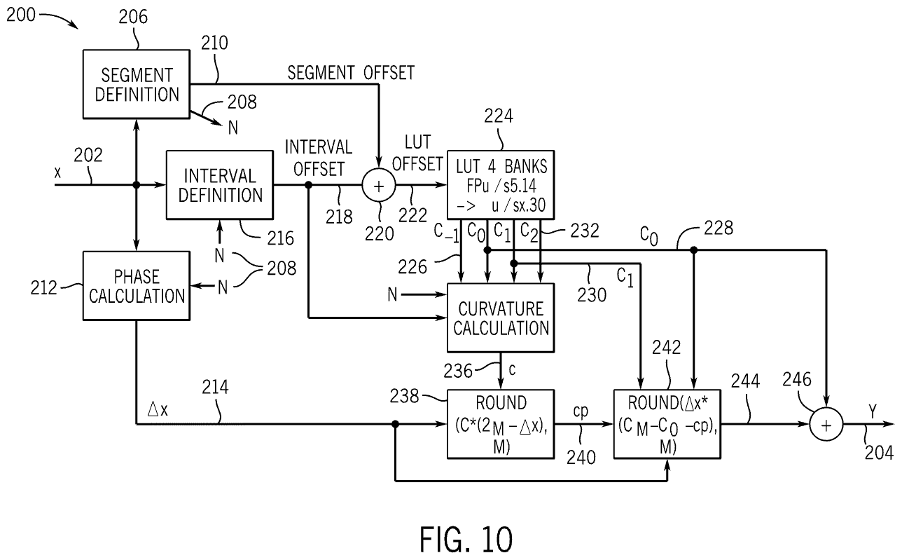

FIG. 10 is a schematic diagram of the curvature interpolation circuitry 72 that determines an output value 204 of an input value 202 based on defined output values of a LUT and coefficients of a curvature measurement. In some embodiments, the curvature interpolation performed by the curvature interpolation circuitry 72 may be performed by software components, other hardware components, or a combination of hardware and software components. As illustrated, the process 200 may include segment definition circuitry 206 that determines a segment definition based on the input value 202. The segment definition may include a number of optimization coefficients 208 and a segment offset 210. The number of optimization coefficients 208 may be determined based on a number of segments of the LUT and a number of intervals in each segment. The segment offset 210 may include or indicate the segment of the LUT that includes the input value 202. The segment may contain one or more entries (e.g., 1, 2, or 4 entries), each entry having a defined input value and a defined output value.

Based on the input value 202 and the number of optimization coefficients 208, phase calculation circuitry 212 may determine a phase 214. As described herein, the phase 214 may include a difference between the input value and one or more defined input values of one or more entries of the LUT. Additionally, interval definition circuitry 216 may determine an interval offset 218 based on the input value 202 and the number of optimization coefficients 208. The interval offset 218 may define differences between defined input values of the entries of the segment with the input value 202. Further, addition circuitry 220 may add the segment offset 210 and the interval offset 218 to produce a LUT offset 222.

Additionally, LUT circuitry 224 may, based on the LUT offset 222, determine a first defined output value 226, a second defined output value 228, a third defined output value 230, and a fourth defined output value 232, which may be provided to curvature calculation circuitry 234. Based on the first defined output value 226, the second defined output value 228, the third defined output value 230, the fourth defined output value 232, and the number of optimization coefficients 208, the curvature calculation circuitry 234 may determine a curvature 236 of a curve. For example, the curvature calculation circuitry 234 may determine the curvature 236 based on a minimization of error values between corresponding values of the curve having the curvature and one or more of the first defined output value 226, the second defined output value 228, the third defined output value 230, and the fourth defined output value 232. As described herein, the error values may include a mean square error between the defined output values and the corresponding values of the curve, and may be calculated as the division between a first convolution and a second convolution. The first convolution may include a Cholesky decomposition of a triangular matrix with four non-zero diagonals. The second convolution may include a convolution between a first matrix and a curvature calculation vector. The curvature calculation vector may include a number of corresponding points of the curve equal to one less than the number of curve calculation values per interval multiplied by the first dimension of the first matrix.

Based on the curvature 236 and the phase 214, first calculation circuitry 238 may determine a first term 240. The first term 240 may be determined based on multiplying the curvature 236 and a sub-term, the sub-term including a difference between a base-two exponential having an exponent equal to a number of curve calculation points per interval (e.g., 1, 2, or 4) and the phase 214. The first term 240 may also be rounded based on the number of curve calculation points per interval.

Second calculation circuitry 242 may determine a second term 244 based on the first term 240, the second defined output value 228, the third defined output value 230, and the phase 214. The second term 244 may be determined based on the phase 214 multiplied by a sub-term. The sub-term may include a difference between a second difference and the first term 240, the second difference being a difference between the third defined output value 230 and the second defined output value 228. The second calculation circuitry 242 may also round the second term 244 based on the number of curve calculation points per interval. Addition circuitry 246 may add the second term 244 and the second defined output value 228 to determine the output value 204.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function]. . .” or “step for [perform]ing [a function]. . .”, it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. Circuitry comprising:
a memory configured to store a plurality of entries respectively mapping a defined input value to a defined output value; and
processing circuitry configured to receive an input value having a value between first and second defined input values, determine coefficients defining a curvature between first and second defined output values corresponding to the first and second defined input values, and determine an output value based on the input value and the curvature defined by the coefficients.

2. The circuitry of claim 1, wherein the processing circuitry is configured to determine the coefficients based on a minimization of an error value between at least three defined output values that include the first and second defined output values.

3. The circuitry of claim 2, wherein the error value comprises a mean square error (MSE) between the at least three defined output values and the corresponding values of the curvature.

4. The circuitry of claim 1, wherein the processing circuitry is configured to determine the coefficients of the curvature to minimize an error value between at least the first and second defined output values and the corresponding values of the curvature based on one or more convolutions.

5. The circuitry of claim 1, wherein the processing circuitry comprises image processing circuitry, the input value comprises input image data, and the output value comprises adjusted image data.

6. The circuitry of claim 5, wherein the processing circuitry is configured to perform a gamma operation to convert the input image data from a linear space to output image data in a gamma space or convert the input image data from the gamma space to output image data in the linear space.

7. The circuitry of claim 1, wherein the processing circuitry comprises image processing circuitry configured to use the plurality of entries to perform a color adjustment, a geometry adjustment, a scaling, or any combination thereof.

8. A display pipeline configured to process image data for display on an electronic display, wherein the display pipeline comprises:
a lookup table (LUT) comprising a plurality of entries of the image data respectively mapping a defined input value to a defined output value; and
processing circuitry configured to process the image data at least in part by:
receiving an input value having a value between first and second defined input values;
determining coefficients defining a curvature between first and second defined output values corresponding to the first and second defined input values; and
determining an output value based on the input value and the curvature defined by the coefficients.

9. The display pipeline of claim 8, wherein the LUT is a one-dimensional LUT or a two-dimensional LUT.

10. The display pipeline of claim 8, wherein the processing circuitry is configured to determine the coefficients based on a minimization of an error value between at least three defined output values that include the first and second defined output values.

11. The display pipeline of claim 10, wherein the error value comprises a mean square error (MSE) between the at least three defined output values and the corresponding values of the curvature.

12. The display pipeline of claim 11, wherein the processing circuitry is configured to determine the MSE between the at least three defined output values and the corresponding values of the curvature based on a left matrix division of a first convolution and a second convolution.

13. The display pipeline of claim 12, wherein the first convolution comprises a Cholesky decomposition and the second convolution comprises a convolution between a first matrix and a second matrix.

14. The display pipeline of claim 13, wherein the second matrix comprises the coefficients.

15. A non-transitory, computer-readable medium comprising instructions that, when executed by processing circuitry, are configured to cause the processing circuitry to process image data at least in part by:
receiving an input value of image data having a value between first and second defined input values of a plurality of entries respectively mapping a defined input value to a defined output value;
determining coefficients defining a curvature between first and second defined output values corresponding to the first and second defined input values; and
determining an output value based on the input value of image data and the curvature defined by the coefficients.

16. The non-transitory, computer-readable medium of claim 15, wherein the input value comprises input image data, and the output value comprises adjusted image data.

17. The non-transitory, computer-readable medium of claim 15, wherein the processing circuitry is configured to determine the coefficients based on a minimization of an error value between at least three defined output values that include the first and second defined output values.

18. The non-transitory, computer-readable medium of claim 17, wherein the instructions, when executed by the processing circuitry, are configured to cause the processing circuitry to perform multiple iterations of determining the coefficients.

19. The non-transitory, computer-readable medium of claim 15, wherein the instructions, when executed by the processing circuitry, are configured to cause the processing circuitry to perform a gamma operation to convert the image data from a linear space to output image data in a gamma space or convert the image data from the gamma space to output image data in the linear space.

20. The non-transitory, computer-readable medium of claim 15, wherein the processing circuitry comprises image processing circuitry configured to use the plurality of entries to perform a color adjustment, a geometry adjustment, a scaling, or any combination thereof.
